(19) United States
(12) Patent Application Publication
(10) Pub. No.: US 2021/0174436 A1
(43) Pub. Date: Jun. 10, 2021

(54) SINGLE APPLICATION FOR TWO DIFFERENT CARDS

(71) Applicant: Wells Fargo Bank, N.A., San Francisco, CA (US)

(72) Inventors: Judy A. Teeven, San Francisco, CA (US); Athena Tracey, San Francisco, CA (US)

(21) Appl. No.: 15/360,032

(22) Filed: Nov. 23, 2016

(51) Int. Cl. G06Q 40/02; G06Q 20/24; G06Q 20/40

(52) U.S. Cl. CPC G06Q 40/025; G06Q 20/405; G06Q 20/24

(57) ABSTRACT

Examples described herein relate to apparatuses and methods for processing two or more credit cards by a financial institution computing system, including but not limited to receiving, from a user, the credit application for applying for two or more credit cards, processing, by the financial institution computing system, the credit application for the two or more credit cards, and issuing, by the financial institution computing system, at least one of the two or more credit cards.

### BACKGROUND

Typically, a customer of a financial institution (e.g., a bank, credit union, company, or the like) can complete an application to apply for a credit card issued by the financial institution. The financial institution is an issuer that issues the credit card to the customer. The credit card is associated with an account of the customer at the financial institution. Usage of the credit card is facilitated by a card network such as, but not limited to, Visa, MasterCard, American Express, and the like. For a given transaction between the customer and a merchant, the card network acts as an intermediary between the financial institution (e.g., the issuer) and an acquirer, which is a financial entity associated with the merchant. In other words, the card network interfaces or otherwise manages transactions between the customer (the financial institution/issuer) and the merchant (the acquirer).

### SUMMARY

Examples described herein relate to a card approval process for two or more cards based on a single credit application (e.g., a single credit application) completed by a user or customer of a financial institution. In some examples, each of the two or more cards is a credit card such as, but not limited to, a cash-back reward card, a travel card, or the like. In some examples, the two or more credit cards are associated or provided by different card networks (such as, but not limited to, Visa, MasterCard, American Express, and the like). Illustrating with a non-limiting example, a first card of the two or more cards is a Visa credit card, and a second credit card of the two or more cards is an American Express credit card. The two or more credit cards are issued by a same issuer. In some examples, the two or more credit cards draw from a same pooled or joint line of credit associated with the user. In other examples, each of the two or more credit cards draws from a different line of credit.

In some examples, a method for processing two or more credit cards by a financial institution computing system includes receiving, from a user, the credit application for applying for two or more credit cards, processing, by the financial institution computing system, the credit application for the two or more credit cards; and issuing, by the financial institution computing system, at least one of the two or more credit cards.

In some examples, a financial institution computing system associated with a financial institution includes a network interface structured to facilitate data communication via a network, a memory, and a processing circuit comprising a processor, the processing circuit configured to receive, from a user, the credit application for applying for two or more credit cards, process, by the financial institution computing system, the credit application for the two or more credit cards; and issue, by the financial institution computing system, at least one of the two or more credit cards.

### BRIEF DESCRIPTION OF THE FIGURES

FIG. 1 is a diagram of an example of a system for processing credit cards according to some arrangements.

FIG. 2 is a diagram of an example of a user device and an example of a financial institution in the computing system set forth in FIG. 1 according to some arrangements.

FIG. 3 is a flow diagram illustrating an example of a method for processing two or more credit cards according to various arrangements.

FIG. 4 is a flow diagram illustrating an example of a method for processing two credit cards according to various arrangements.

FIG. 5 is a flow diagram illustrating an example of a method for processing three credit cards according to various arrangements.

FIG. 6 is a diagram of an example of a display user interface outputted by an input/output circuit of a user device presenting information related to a credit application based on which two or more credit cards can be processed.

FIG. 7 is a diagram of an example of a display user interface outputted by an input/output circuit of a user device presenting information related to two or more credit cards approved.

### DETAILED DESCRIPTION

Referring generally to the Figures, systems, methods, and apparatuses for processing a credit application for two or more credit cards are described herein. In particular, a single application completed by a credit card applicant (e.g., a customer or potential customer of a financial institution) can be used by a financial institution as a basis for approving two or more credit cards, instead of requiring the applicant to fill out different applications for different credit cards. Processing the credit application for two or more credit cards includes one or more of analyzing the credit worthiness of the credit application (including, for example, requesting and analyzing credit bureau information about the applicant, verifying applicant identity, verifying applicant income and debts, and the like.), determining whether to provide credit to the applicant based on their credit worthiness, and the like based on the received credit application. In some arrangements, each of the two or more credit cards are issued by the same financial institution. In some arrangements, each of the two or more credit cards undergoing the approval process based on the single credit application is associated with a different card network. In other arrangements, two or more credit cards undergoing the approval process based on the single credit application are associated with a same card network. In some arrangements, two credit cards draw from a same line of credit. In other arrangements, two credit cards draw from different lines of credit.

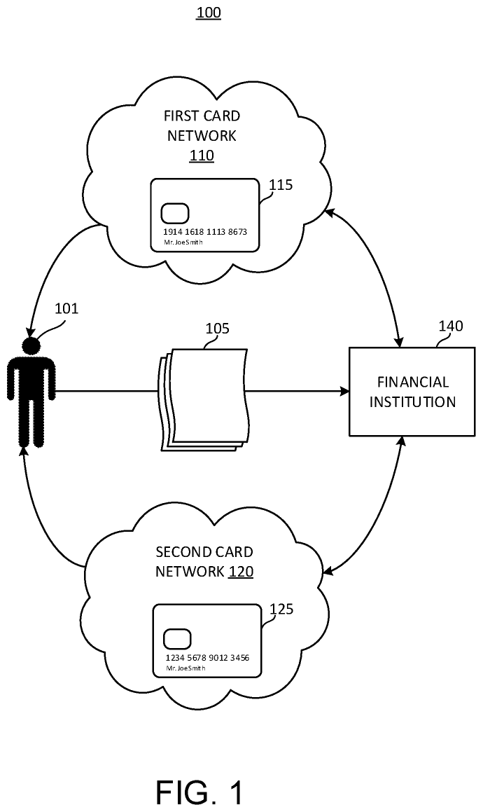

FIG. 1 is a diagram of an example of a system 100 for processing a credit application for credit cards 115 and 125 according to some arrangements. Referring to FIG. 1, a user 101 is a customer or potential customer of a financial institution 140. The user 101 may include any of individuals, business representatives, large and small business owners, and any other entity. In some configurations in which the user 101 is a customer of the financial institution 140, the user 101 has at least one financial account at the financial institution 140. In other configurations in which the user 101 is a potential customer of the financial institution 140, one or more financial accounts are created at the financial institution 140, for instance, corresponding to the credit cards 115 and 125.

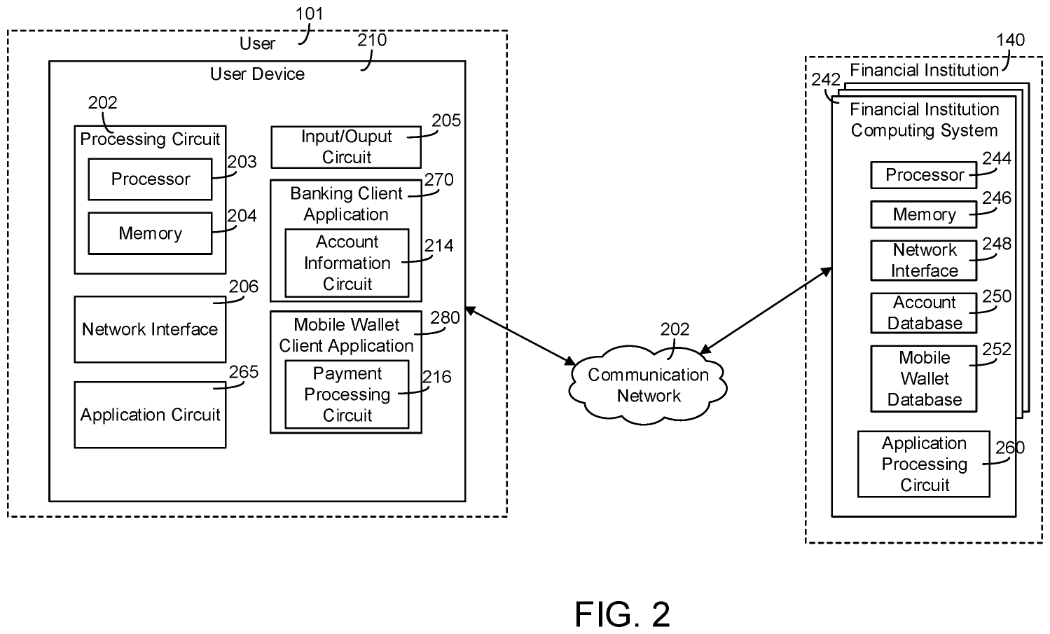

In some arrangements, the user 101 completes a credit application 105 for obtaining two or more credit cards (such as, but not limited to, the credit cards 115 and 125). In some instances, the credit application 105 is an electronic application form completed via a user device 210 (FIG. 2) operated by the user 101 or completed by a staff (e.g., by a personal banker) of the financial institution 140. In other instances, the credit application 105 is a paper application completed by the user 101 and delivered to the financial institution 140 through suitable methods. The credit application 105 includes information about the user 101, such as, but not limited to, name, address, date of birth, telephone number, email address, citizenship, social security number, security passcodes, housing status, mortgage/rent payments, employment status, employment information, income, sources of income, or the like.

In some arrangements, the credit application 105 is a general application form and does not indicate one or more of a number of credit cards being processed and/or issued based on the credit application 105, type(s) of credit card(s) being processed and/or issued based on the credit application 105, terms and conditions of credit card(s) being processed and/or issued based on the credit application 105, features of credit card(s) being processed and/or issued based on the credit application 105, or the like. In other arrangement, the credit application 105 indicates all of the number of credit cards being processed and/or issued based on the credit application 105, type(s) of credit card(s) being processed and/or issued based on the credit application 105, terms and conditions of credit card(s) being processed and/or issued based on the credit application 105, features of credit card(s) being processed and/or issued based on the credit application 105, or the like.

Upon receiving the credit application 105, the financial institution 104, through a financial institution computing system 242 (FIG. 2) proceeds with review and approval processes for both the first credit card 115 associated with the credit application 105 and the second credit card 125 associated with the credit application 105. For instance, based on the information contained in the credit application 105, the financial institution 104 determines whether to approve the first credit card 115 and the second credit card 125. In some scenarios, both the first credit card 115 and the second credit card 125 are approved. In other scenarios, one or both of the first credit card 115 and the second credit card 125 are denied.

The first credit card 115 is associated with a first card network 110. The second credit card 125 is associated with a second card network 120. Each of the first card network 110 and second card network 120 is a card network such as, but not limited to, Visa, MasterCard, American Express, and the like. For a given transaction between the user 101 and a merchant using the first credit card 115, the first card network 110 acts as an intermediary between the financial institution 104 and an acquirer associated with the merchant. The same is applicable to the second card network 120 with respect to the second credit card 125. In some arrangements, the first card network 110 and the second card network 120 are different card networks. Illustrating with a non-limiting example, the first card network 110 is a Visa network (e.g., the first credit card 115 is a Visa credit card), and the second card network 120 is an American Express network (e.g., the second credit card 125 is an American Express network). In other arrangements, the first card network 110 and the second card network 120 are a same card network.

While FIG. 1 illustrates two credit cards 115 and 125 (and two card networks 110 and 120) associated with the credit application 105, one of ordinary skill in the art can appreciate that three or more credit cards can be likewise processed based on the same credit application 105 in a similar manner.

FIG. 2 is a diagram of an example of a user device 210 and an example of a financial institution 140 in the system 100 set forth in FIG. 1 according to some arrangements. Referring now to FIGS. 1-2, the user device 210 is associated with the user 101, and the financial institution 140 has at least one associated financial institution computing system 242. The user device 210 and the financial institution computing system 242 are communicably and operatively coupled to each other over a network 202. The network 202 is any suitable type of network. For example, the network 202 is a wireless network interface (e.g., 802.11X, ZigBee, Bluetooth, Internet, etc.), a wired network interface (e.g., Ethernet), or any combination thereof. The network 202 is structured to permit the exchange of data, values, instructions, messages, and the like between and among the user device 210 and the financial institution computing system 242.

As shown, the financial institution 140 provides financial products (e.g., the credit cards 115 and 125) and services to the user 101 via the financial institution computing system 242. The financial institution computing system 242 includes a processor 244 and a memory device 246. The processor 244 is implemented as a general-purpose processor, an Application Specific Integrated Circuit (ASIC), one or more Field Programmable Gate Arrays (FPGAs), a Digital Signal Processor (DSP), a group of processing components, or other suitable electronic processing components. The memory 246 (e.g., Random Access Memory (RAM), Read-Only Memory (ROM), Non-volatile RAM (NVRAM), Flash Memory, hard disk storage, etc.) stores data and/or computer code for facilitating at least some of the various processes described herein. The memory 286 is or includes tangible, non-transient volatile memory or non-volatile memory. In this regard, the memory 246 stores programming logic that, when executed by the processor 244, controls the operations of the financial institution computing system 242.

As shown, the financial institution computing system 242 includes a network interface 248. The network interface 248 is structured for sending and receiving of data over the network 202 (e.g., to and from the user device 210, etc.). Accordingly, the network interface 248 includes any of a cellular transceiver (e.g., Frequency Division Multiple Access (FDMA), Time Division Multiple Access (TDMA), Code Division Multiple Access (CDMA) (particularly, Evolution-Data Optimized (EVDO)), Universal Mobile Telecommunications Systems (UMTS) (particularly, Time Division Synchronous CDMA (TD-SCDMA or TDS) Wideband Code Division Multiple Access (WCDMA), Long Term Evolution (LTE), evolved Multimedia Broadcast Multicast Services (eMBMS), High-Speed Downlink Packet Access (HSDPA), and the like), Universal Terrestrial Radio Access (UTRA), Global System for Mobile Communications (GSM), Code Division Multiple Access 1× Radio Transmission Technology (1×), General Packet Radio Service (GPRS), Personal Communications Service (PCS), etc.), a wireless network transceiver (e.g., 802.11X, ZigBee, Bluetooth, Wi-Fi, etc.), wired network interface, combination thereof (e.g., both a cellular transceiver and a Bluetooth transceiver), and/or the like.

The financial institution computing system 242 includes an account database 250 that stores customer information and account information relating to one or more accounts held by the user 101 with the financial institution 140. In this regard and as mentioned, more than one financial institution (such as, but not limited to, the financial institution 140) with an associated financial institution computing system (such as, but not limited to, the financial institution computing system 242) can be communicably coupled to the components of FIG. 2 over the communication network 202 to access the accounts held by the user 101. As further shown, the financial institution computing system 242 includes a mobile wallets account database 252 for storing mobile wallet accounts of users, including the user 101. As described herein, the mobile wallet accounts permit payments via the mobile wallet client application 280 of the user device 210.

The financial institution computing system 242 includes an application processing circuit 260. The application processing circuit 260 is configured to perform one or more of determining whether to approve the credit cards 115 and 125, the credit line of each approved credit card, issuing of each approved credit card, or the like. In some arrangements, the application processing circuit 260 is implemented within the processor 244. For example, the application processing circuit 260 is implemented as a software application stored within the memory 246 and executed by the processor 244. Accordingly, such examples can be implemented with minimal additional hardware costs. However, other examples relate to apparatuses and methods implemented with dedicated hardware specifically configured for performing operations described herein with respect to the application processing circuit 260. For example, the application processing circuit 260 can be implemented with a processing component separate from the processor 244.

As shown, the user 101 operates or is associated with the user device 210. In some arrangements, the user device 210 is a mobile device. The mobile device includes any wearable device. Wearable devices refer to any type of device that a user can wear, including, but not limited to, a watch (e.g., a smart watch), glasses (e.g., eye glasses, sun glasses, smart glasses, etc.), bracelet (e.g., a smart bracelet), etc. The mobile device includes, but not limited to, a phone (e.g., a smartphone, etc.) and a computing device (e.g., a tablet computer, a laptop computer, a person digital assistant, etc.). In some arrangements, the user device 210 is a computing device such as, but not limited to, a desktop computer, server, or other types of computing device. Accordingly, the user device 210 includes a display device (e.g., a screen) and one or more input/output devices (e.g., a touch screen, microphone, speaker, keyboard, etc.), collectively referred to as an input/output circuit 205 for receiving user input from the user 101 and/or outputting information to the user 101.

In some arrangements, the user device 210 includes a processing circuit 202 having a processor 203 and a memory 204. The processor 203 is implemented as a general-purpose processor, an ASIC, one or more FPGAs, a DSP, a group of processing components that are distributed over various geographic locations or housed in a single location or device, or other suitable electronic processing components. The memory 204 (e.g., RAM, NVRAM, ROM, Flash Memory, hard disk storage, etc.) stores data and/or computer code for facilitating the various processes described herein. Moreover, the memory 204 is or includes tangible, non-transient volatile memory or non-volatile memory. Accordingly, the memory 204 includes database components, object code components, script components, or any other type of information structure for supporting the various activities and information structures described herein.

The user device 210 is shown to include various circuits and logic for implementing the activities described herein. More particularly, the user device 210 includes an input/output circuit 205, network interface 206, mobile wallet client application 280, banking client application 270, and application circuit 265. While various circuits, interfaces, and logic with particular functionality are shown, it should be understood that the user device 210 includes any number of circuits, interfaces, and logic for completing the functions described herein. For example, the activities of multiple circuits are combined as a single circuit and implemented on a same processing circuit (e.g., the processing circuit 202), as additional circuits with additional functionality are included, etc.

The network interface 206 is configured for and structured to establish a communication session via the network 202 with the financial computing system 142. Accordingly, the network interface 206 is an interface such as, but not limited to, the network interface 248.

The input/output circuit 205 is configured to receive user input from and provide information to the user 101. In this regard, the input/output circuit 205 is structured to exchange data, communications, instructions, etc. with an input/output component of the device 110. Accordingly, in some arrangements, the input/output circuit 205 includes an input/output device such as a display device, touchscreen, keyboard, microphone, and/or the like. In some arrangements, the input/output circuit 205 includes communication circuitry for facilitating the exchange of data, values, messages, and the like between the input/output device and the components of the user device 210 (e.g., the application circuit 265). In some arrangements, the input/output circuit 205 includes machine-readable media for facilitating the exchange of information between the input/output device and the components of the user device 210 (e.g., application circuit 265). In still another arrangement, the input/output circuit 205 includes any combination of hardware components (e.g., a touchscreen), communication circuitry, and machine-readable media.

The user device 210 includes an application circuit 265, banking client application 270, and mobile wallet client application 280. One or more of the application circuit 265, banking client application 270, or mobile wallet client application 280 are server-based applications executable on the user device 210. In this regard, the user 101 has to first download the application(s) prior to usage. In another arrangement, the application circuit 265, banking client application 270, and/or mobile wallet client application 280 are hard coded into the memory 204 of the user device 210. In still another arrangement, the application circuit 265, banking client application 270, and/or mobile wallet client application 280 are web-based interface applications. In this configuration, the user 101 has to log onto or access the web-based interface before usage. In this regard, at least one of the application circuit 265, banking client application 270, and mobile wallet client application 280 is supported by a separate computing system comprising one or more servers, processors, network interface modules, etc. that transmit the applications for use to the user device 210. In certain arrangements, one or more of the application circuit 265, banking client application 270, and/or mobile wallet client application 280 include an Application Programming Interface (API) and/or a Software Development Kit (SDK) that facilitate integration of other applications with the one or more of the application circuit 265, banking client application 270, or mobile wallet client application 280. All such variations and combinations are intended to fall within the spirit and scope of the present disclosure.

The banking client application 270 is communicably coupled to the financial institution computing system 242 (e.g., the account database 250) via the network 202 and is structured to permit management of at least one account of the user 101 via the banking client application 270. In this regard, the banking client application 270 provides displays indicative of account information such as, but not limited to, current account balances, pending transactions, profile information (e.g., contact information), reward associated with the account, bill pay information and/or the like. Further, in some arrangements, the banking client application 270 is configured to process payments from the user 101 to a designated recipient. For example, the banking client application 270 depicts a loan (e.g., mortgage) of the user 101 and allows the user 101 to pay the mortgage from an account (e.g., checking or savings). In some examples, a bill pay option is provided by the banking client application 270, where the bill pay option allows the user 101 to pay his/her bills in response to user input.

As mentioned herein, via the banking client application 270, the user 101 pays bills (e.g., mortgage, etc.), view balances, and otherwise manage their account. Accordingly and as shown, the mobile bank client application 270 includes an account information circuit 214. The account information circuit 214 is linked or otherwise coupled to one or more accounts held by the user 101 and permit management of the associated accounts (e.g., transfer balances between accounts, see payment history, etc.). The banking client application 270 is also communicably coupled to the mobile wallet client application 280. As such, in response to a mobile payment via the application 280, the application 280 causes the banking client application 270 to update the payment account (i.e., the account that supported the mobile payment). As such, the mobile wallet and banking client applications 280 and 270 are communicably coupled to each other to enable actions supported by each respective application.

The mobile wallet client application 280 is communicably coupled to the financial institution computing system 242 (e.g., the mobile wallets database 252) via the communication network 202 and is structured to facilitate purchases by the user 101 via the mobile wallet client application 280. Accordingly, the mobile wallet client application 280 is linked or otherwise connected with one or more accounts of the user 101. In operation, when at a point-of-sale terminal, the user 101 initiates the mobile wallet client application 280 and provides a passcode (e.g., biometrics such as a thumbprint, a Personal Identification Number (PIN), a password, etc.) to authenticate the user 101 and select the source payment account desired (e.g., a checking account from a particular financial institution that is linked to the mobile wallet client application 280). Via communication with the payment terminal (e.g., via near field communication), the aforementioned payment information is provided and the payment processed. Beneficially, carrying payment cards are avoided or reduced via the mobile wallet client application 280.

As mentioned herein, the mobile wallet client application 280 is structured to facilitate and permit payments by interfacing with an account (e.g., a credit card account associated with one or more of the credit cards 115 and 125) held by the user 101 at the financial institution 140. Accordingly, the mobile wallet client application 280 is communicably coupled via the network interface 206 over the communication network 202 to the financial institution computing system 242. As shown, the mobile wallet client application 280 includes a payment processing circuit 216 structured to facilitate payments by the user 101 via the mobile wallet client application 280. For example, the payment processing circuit 216 enables a quick-pay capability with a merchant. In this regard, the payment processing circuit 216 includes or be communicably coupled with a communication device (e.g., a near-field communication chip) that facilitates the exchange of information between the mobile wallet client application 280 and a point-of-sale terminal.

The application circuit 265 is communicably coupled to the financial institution computing system 242 (e.g., the application processing circuit 260) via the network 202 and is structured to facilitate processing the credit application 105. For instance, a form corresponding to the credit application 105 is displayed by the input/output circuit 205 configured by the application circuit 265. The input/output circuit 205 receives user input and relay the user input to the application circuit 265, which configures the network interface 206 to send the credit application 105 (including the user input) via the communication network 202 to the application processing circuit 260 for processing.

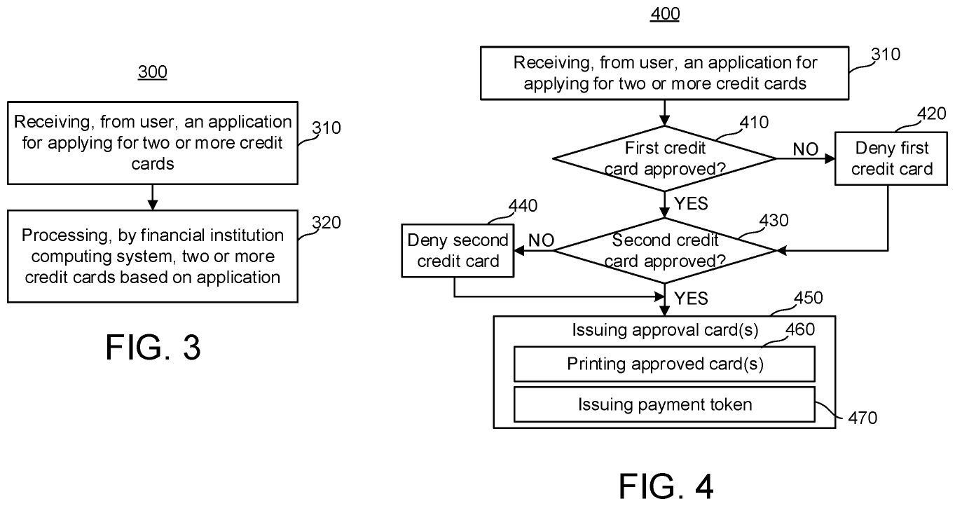

FIG. 3 is a flow diagram illustrating an example of a method 300 for processing two or more credit cards (e.g., the credit cards 115 and 125 of FIG. 1) according to various arrangements. Referring to FIGS. 1-3, the method 300 is a general method for underwriting and processing two or more credit cards based on a single credit application (e.g., the credit application 105) containing information about the user 101. The method 300 is performed by at least the financial institution computing system 242 (e.g., the application processing circuit 260 and/or the processor 244).

At 310, the financial institution computing system 242 receives, from the user 101, the credit application 105 for applying for two or more credit cards. For instance, the application processing circuit 260 and/or the processor 244 can configure the network interface 248 to receive the credit application 105 electronically via the communication network 202 from the user device 210 associated with the user 101. The credit application 105 is a single application/document and/or is transmitted to the financial institution computing system 242 as a single file. Accordingly, the user only needs to submit a single credit application for two or more credit cards instead of submitting a unique credit application for each credit card that the user wishes to apply for. In some arrangements, the credit application 105 is an electronic application form completed by the user 101 via the input/output circuit 205 of the user device 210. The credit application 105 is sent by the network interface 206 via the communication network 202 to the financial institution computing system 242. In some arrangements, the credit application 105 for the two or more credit cards is transmitted to the financial institution computing system 242 as a single file (e.g., a single digital file) at a given instance.

The credit application 105 includes information about the user 101, such as, but not limited to, name, address, date of birth, telephone number, email address, citizenship, social security number, security passcodes, housing status, mortgage/rent payments, employment status, employment information, income, sources of income, or the like.

In other arrangements not shown, the credit application 105 can be electronically completed by a staff (e.g., by a personal banker) of the financial institution 140 via any suitable computing platforms (e.g., the financial institution computing system 242 or another similar computing device) and sent to the financial institution computing system 242. In some arrangements, the credit application 105 is a paper credit application completed by the user 101 or the staff of the financial institution 140 and delivered to the financial institution 140 through suitable methods (e.g., postal services).

In some arrangements, the credit application 105 is a general application form and does not indicate or does not allow the user 101 to select one or more of: a number (e.g., two or more) of credit cards being processed and/or issued based on the credit application 105; type(s) of credit card(s) being processed and/or issued based on the credit application 105; terms and conditions of credit card(s) being processed and/or issued based on the credit application 105; features of credit card(s) being processed and/or issued based on the credit application 105, or the like. In other arrangement, the credit application 105 indicates or allow the user 105 to select all of: the number of credit cards being processed and/or issued based on the credit application 105; type(s) of credit card(s) being processed and/or issued based on the credit application 105; terms and conditions of credit card(s) being processed and/or issued based on the credit application 105; features of credit card(s) being processed and/or issued based on the credit application 105, or the like.

At 320, the financial institution computing system 242 (e.g., the application processing circuit 260 and/or the processor 244) causes the two or more credit cards to be processed based on the credit application 105. That is, an approval process corresponding to each of the credit cards 115 and 125 (as well as any additional credit cards) is initiated responsive to receiving the credit application 105. In some arrangements, each of the two or more credit cards (e.g., 115 and 125) is associated with a different card network (e.g., the first card network 110 or the second card network 120, respectively). In other arrangements, at least two of the two or more credit cards undergoing the approval processes based on the single credit application 105 are associated with a same card network. Processing the credit application 105 for two or more credit cards includes one or more of analyzing the credit worthiness of the credit application 105 (including, for example, requesting and analyzing credit bureau information about the user 101 based on the information contained in the credit application 105, verifying identity of the user 101 based on the information contained in the credit application 105, verifying applicant income and debts of the user 101 based on the information contained in the credit application 105, and the like.), determining whether to provide credit to the user 101 based on their credit worthiness, and the like.

In some arrangements, the two or more credit cards draw from a same line of credit associated with the user 101. Illustrating with a non-limiting example, responsive to receiving the credit application 105, the financial institution computing system 242 (e.g., the application processing circuit 260 and/or the processor 244) determines a shared credit line from which at least two of the two or more credit cards draw based on the information contained in the credit application 105. In some arrangements, at least two of the two or more credit cards draw from different lines of credit. In the cases in which at least two (e.g., 115 and 125) of the two or more credit cards draw from different lines of credit, a first line of credit associated with the first credit card 115 is different from a second line of credit associated with the second credit card 125. Illustrating with a non-limiting example, responsive to receiving the credit application 105, the financial institution computing system 242 (e.g., the application processing circuit 260 and/or the processor 244) determines a first credit line from which the first credit card 115 draws based on the information contained in the credit application 105, and a second credit line from which the second credit card 125 draws based on the information contained in the credit application 105.

FIG. 4 is a flow diagram illustrating an example of a method 400 for processing two or more credit cards (e.g., the credit cards 115 and 125 of FIG. 1) according to various arrangements. Referring to FIGS. 1-4, the method 400 is an example of a particular implementation of the method 300 relative to, for example, the two credit cards 115 and 125 based on a single credit application (e.g., the credit application 105) containing information about the user 101. The method 400 is performed by the financial institution computing system 242 (e.g., the application processing circuit 260 and/or the processor 244). Particularly, 320 corresponds to 410-450. At 310, the financial institution computing system 242 receives, from the user 101, the credit application 105 for applying for two or more credit cards in the manner described.

At 410, the financial institution computing system 242 (e.g., the application processing circuit 260 and/or the processor 244) determines whether the first credit card 115 is approved. The approval process with respect to the first credit card 115 includes or is associated with at least an underwriting process. For instance, based on the information contained in the credit application 105, information (if any) contained in the account database 250, information (if any) contained in the mobile wallet database 252, or the like, the application processing circuit 260 (and/or an underwriter) in some arrangements determines whether to approve the first credit card 115 and/or determines a credit line associated with the first credit card 115. Determining whether to approve the first credit card 115 includes, for instance, one or more of analyzing the credit worthiness of the credit application 105 (including, for example, requesting and analyzing credit bureau information about the user 101 based on the information contained in the credit application 105, verifying identity of the user 101 based on the information contained in the credit application 105, verifying applicant income and debts of the user 101 based on the information contained in the credit application 105, and the like.), determining whether to provide credit to the user 101 based on their credit worthiness in relation to the first credit card 115, and the like. Illustrating with a non-limiting example, factors such as, but not limited to, a credit score, card utilization, credit inquiries, history of opened accounts, delinquencies, mortgage, loan history, or the like associated with the user 101 can be determined based on the information provided in the credit application 105 and/or the information contained in the account database 250 and/or the mobile wallet database 252. Based such factors, the application processing circuit 260 (and/or the underwriter) determines whether to approve the first credit card 115 and/or to determine a credit line associated with the first credit card 115. In some arrangements in which the credit cards 115 and 125 share a same line of credit, the underwriting process associated with 410 includes determining credit worthiness of the user 101 in view of the two credit cards 115 and 125 sharing a same line of credit. On the other hand, the underwriting process associated with 410 is based on the fact that the credit cards 115 and 125 using separate lines of credit in the arrangements in which the credit cards 115 and 125 draw from separate lines of credit.

In response to determining that the first credit card 115 is not approved (410:NO), the financial institution computing system 242 (e.g., the application processing circuit 260 and/or the processor 244) denies the first credit card 115 at 420. In some arrangements, the financial institution computing system 242 (e.g., the application processing circuit 260 and/or the processor 244) sends a message via the network 202 to the user device 210 informing the user 101 that the first credit card 115 is denied. The input/output circuit 205 is caused by the application circuit 265 to display the message to the user 101. In some arrangements, the financial institution computing system 242 (e.g., the application processing circuit 260 and/or the processor 244) automatically causes a letter to be printed and sent via postal services to an address of the user 101 to inform the user 101 that the first credit card 115 is denied. The method 400 then proceeds to 430.

On the other hand, in response to determining that the first credit card 115 is approved (410:YES), the financial institution computing system 242 (e.g., the application processing circuit 260 and/or the processor 244) determines whether the second credit card 125 is approved, at 430. The approval process for the second credit card 125 is similar to described with respect to the first credit card 115 (e.g., at 410). For instance, the application processing circuit 260 (and/or the underwriter) determines whether to approve the second credit card 125 and/or to determine a credit line associated with the second credit card 125. In some arrangements in which the credit cards 115 and 125 share a same line of credit, the underwriting process associated with 430 includes determining credit worthiness of the user 101 in view of the two credit cards 115 and 125 sharing a same line of credit. On the other hand, the underwriting process associated with 430 is based on the fact that the credit cards 115 and 125 using separate lines of credit in the arrangements in which the credit cards 115 and 125 draw from separate lines of credit. Nevertheless, one should note that differences may exist between the approval processes of the credit cards 115 and 125 based on the type or nature of each of the credit cards 115 and 125. Illustrating with a non-limiting example in which the first credit card 115 is a cash-back reward card and the second credit card 125 is a travel card, the approval process for the first credit card 115 corresponds to one associated with the cash-back reward card while the approval process for the second credit card 125 corresponds to one associated with the travel card. Illustrating with another non-limiting example, reward programs (if any) associated with the credit card 115 and the second credit card 125 are different, based on the types or conditions of the credits 115 and 125 applied and/or approved

In response to determining that the second credit card 112 is not approved (430:NO), the financial institution computing system 242 (e.g., the application processing circuit 260 and/or the processor 244) denies the second credit card 125 at 440 in a manner similar to described with respect to 420. The method 400 then proceeds to 450. On the other hand, in response to determining that the second credit card 125 is approved (430:YES), the financial institution computing system 242 (e.g., the application processing circuit 260 and/or the processor 244) issues the approved ones of the credit cards 115 and 125 at 450.

In some arrangements, issuing the approved ones of the credit cards 115 and 125 at 450 includes automatically causing, by the financial institution computing system 242 (e.g., the application processing circuit 260 and/or the processor 244), a printer connected to the financial institution computing system 242 to print or otherwise manufacture the approved ones of the credit cards 115 and 125 at 460. In some arrangements, issuing the approved ones of the credit cards 115 and 125 at 450 includes issuing, by the financial institution computing system 242 (e.g., the application processing circuit 260 and/or the processor 244), payment tokens to at least one account of the user 101 associated with the approved ones of the credit cards 115 and 125 at 470. The payment tokens can be based on standards such as, but not limited to, X9, Visa tokens, Point-to-Point Encryption (P2PE), Europay, MasterCard, and Visa (EMV), or the like. Illustrating with a non-limiting example, the payment tokens can be Android payment tokens, apple pay tokens, or the like. The account can be stored at the account database 250 and/or the mobile wallet database 252. In some arrangements, at least one account is created at the account database 250 and/or the mobile wallet database 252 responsive to approving the first credit card 115 (410:YES) and/or approving the second credit card 125 (430:YES).

While in the non-limiting example shown in FIG. 4, the first credit card 115 and the second credit card 125 are shown to be undergoing the approval processes sequentially, one of ordinary skill in the art can appreciate that the credit cards 115 and 125 can be approved in any suitable sequence or simultaneously. In some arrangements, in response to approving the first credit card 115 (410:YES) and/or in response to approving the second credit card 125 (520:YES), an account (e.g., within the account database 250, mobile wallet database 252, and/or the like) associated with the credit cards 115 and 125 is created. An identifier (e.g., an account number) associated with both the credit cards 115 and 125 is the same, even though the credit card numbers of the credit cards 115 and 125 are not the same.

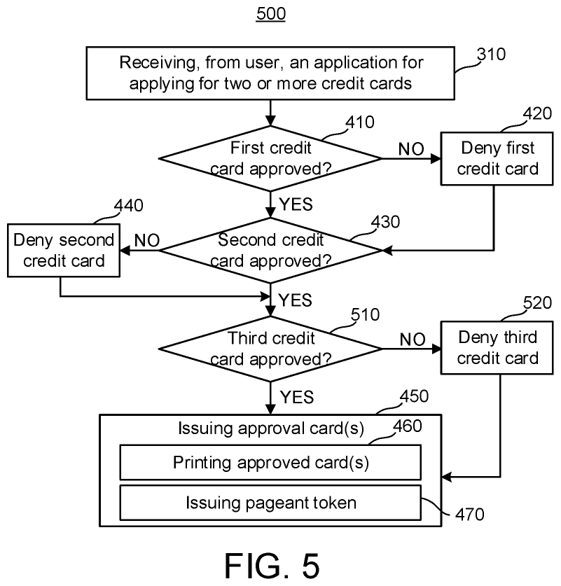

While the non-limiting example shown in FIG. 4 is concerned with two credit cards 115 and 125, one of ordinary skill in the art can appreciate that the general method 300 can be applicable to three or more credit cards. To that point, FIG. 5 is a flow diagram illustrating an example of a method 500 for processing three credit cards (e.g., the credit cards 115 and 125 of FIG. 1 as well as an additional third credit card (not shown)) according to various arrangements. Referring to FIGS. 1-5, the method 500 is an example of a particular implementation of the method 300 relative to the three credit cards based on a single credit application (e.g., the credit application 105) containing information about the user 101. The method 500 is performed by the financial institution computing system 242 (e.g., the application processing circuit 260 and/or the processor 244). Particularly, 320 corresponds to 410-450 and 510-520.

At 310, the financial institution computing system 242 receives, from the user 101, the credit application 105 for applying for two or more credit cards in the manner described. At 410, the financial institution computing system 242 (e.g., the application processing circuit 260 and/or the processor 244) determines whether the first credit card 115 is approved in the manner described. In response to determining that the first credit card 115 is not approved (410:NO), the financial institution computing system 242 (e.g., the application processing circuit 260 and/or the processor 244) denies the first credit card 115 at 420. The method 500 then proceeds to 430. On the other hand, in response to determining that the first credit card 115 is approved (410:YES), the financial institution computing system 242 (e.g., the application processing circuit 260 and/or the processor 244) determines whether the second credit card 125 is approved, at 430. In response to determining that the second credit card 112 is not approved (430:NO), the financial institution computing system 242 (e.g., the application processing circuit 260 and/or the processor 244) denies the second credit card 125 at 440 in the manner described. The method 500 then proceeds to 510.

On the other hand, in response to determining that the second credit card 125 is approved (430:YES), the financial institution computing system 242 (e.g., the application processing circuit 260 and/or the processor 244) determines whether a third credit card is approved at 510 in the manner similar to described with respect to 410 or 430. In response to determining that the third credit card is not approved (510:NO), the financial institution computing system 242 (e.g., the application processing circuit 260 and/or the processor 244) denies the third credit card at 520 in a manner similar to described with respect to 420 or 440. The method 500 then proceeds to 450. On the other hand, in response to determining that the third credit card is approved (510:YES), the financial institution computing system 242 (e.g., the application processing circuit 260 and/or the processor 244) issues the approved ones of the credit cards at 450 in the manner described.

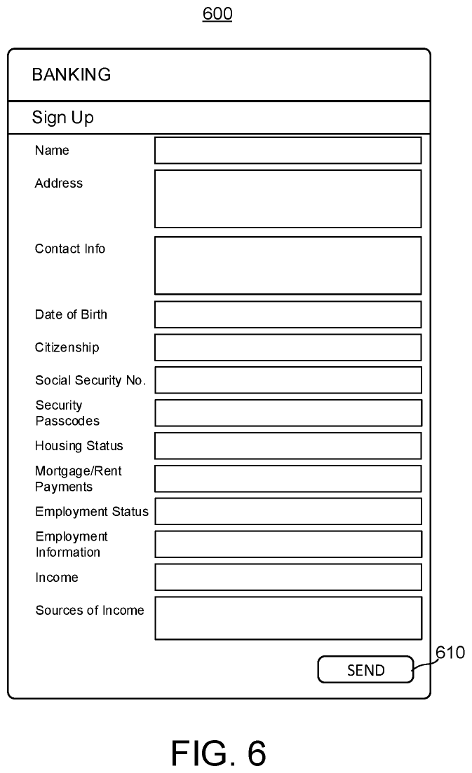

FIG. 6 is a diagram of a display user interface 600 outputted by the input/output circuit 205 (FIG. 2) of the user device 210 (FIG. 2), presenting the credit application 105 (FIG. 1) being completed by the user 101 electronically. Referring to FIGS. 1-6, the display user interface 600 is provided by a user interface aspect of one or more of the banking client application 270, mobile wallet client application 280, or application circuit 265 to be displayed by the input/output circuit 205. In some arrangements, the display user interface 600 is displayed in response to the user 101 selecting, via the input/output circuit 205, to apply for two or more credit cards via interfaces provided by the banking client application 270, mobile wallet client application 280, or application circuit 265.

The display user interface 600 includes user interactive elements for one or more of the name, address, date of birth, telephone number, email address, citizenship, social security number, security passcodes, housing status, mortgage/rent payments, employment status, employment information, income, sources of income, or the like. In some arrangements, the display user interface 600 shows one or more of the number of credit cards being processed and/or issued based on the credit application 105, type(s) of credit card(s) being processed and/or issued based on the credit application 105, terms and conditions of credit card(s) being processed and/or issued based on the credit application 105, features of credit card(s) being processed and/or issued based on the credit application 105, or the like. In some arrangements, the display user interface 600 does not show any of the number of credit cards being processed and/or issued based on the credit application 105, type(s) of credit card(s) being processed and/or issued based on the credit application 105, terms and conditions of credit card(s) being processed and/or issued based on the credit application 105, features of credit card(s) being processed and/or issued based on the credit application 105, or the like. The display user interface 600 includes a transmittal user interactive element 610. In response of the transmittal user interactive element 610 being selected, the user device 210 (e.g., the network interface 205) transmits the completed credit application 105 to the financial institution computing system 242 through the communication network 202.

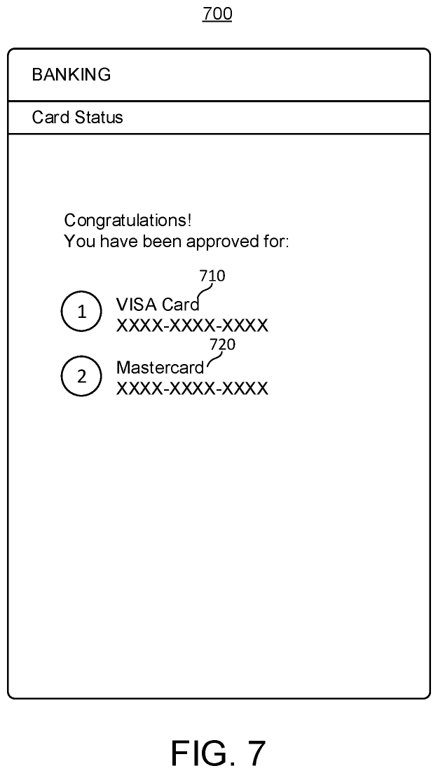

FIG. 7 is a diagram of a display user interface 700 outputted by the input/output circuit 205 (FIG. 2) of the user device 210 (FIG. 2) presenting outcome of approval processes based on the credit application 105 (FIG. 1) received from the user device 210. Referring to FIGS. 1-7, the display user interface 700 is provided by a user interface aspect of one or more of the banking client application 270, mobile wallet client application 280, or application circuit 265 to be displayed by the input/output circuit 205. In some arrangements, the display user interface 700 is displayed in response to receiving, via the communication network 202, information related to the outcome of the approval processes based on the credit application 105. The outcomes of the approval processes for each of the credit cards (e.g., 115 and 125) associated with the credit application 105 can be determined, for example, at 410, 430, 510, or the like.

In the non-limiting example shown in FIG. 7, the user 101 is approved for a Visa credit card 710 and a MasterCard credit card 720. The display user interface 700 displays additional information such as, but not limited to, the card numbers associated with each of the Visa credit card 710 and MasterCard credit card 720.

The arrangements described herein have been described with reference to drawings. The drawings illustrate certain details of specific arrangements that implement the systems, methods and programs described herein. However, describing the arrangements with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some arrangements, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some arrangements, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some arrangements, the one or more processors may be embodied in various ways. The one or more processors may be constructed in a manner sufficient to perform at least the operations described herein. In some arrangements, the one or more processors may be shared by multiple circuits (e.g., circuit A and circuit B may comprise or otherwise share the same processor which, in some example arrangements, may execute instructions stored, or otherwise accessed, via different areas of memory). Alternatively or additionally, the one or more processors may be structured to perform or otherwise execute certain operations independent of one or more co-processors. In other example arrangements, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some arrangements, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

An exemplary system for implementing the overall system or portions of the arrangements might include a general purpose computing computers in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some arrangements, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other arrangements, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example arrangements described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative arrangements. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule based logic and other logic to accomplish the various database searching steps, correlation steps, comparison steps and decision steps.

The foregoing description of arrangements has been presented for purposes of illustration and description. It is not intended to be exhaustive or to limit the disclosure to the precise form disclosed, and modifications and variations are possible in light of the above teachings or may be acquired from this disclosure. The arrangements were chosen and described in order to explain the principals of the disclosure and its practical application to enable one skilled in the art to utilize the various arrangements and with various modifications as are suited to the particular use contemplated. Other substitutions, modifications, changes and omissions may be made in the design, operating conditions and arrangement of the arrangements without departing from the scope of the present disclosure as expressed in the appended claims.

1. A method for processing a credit application for two or more credit cards by a financial institution computing system, comprising:
receiving, by a financial institution computing system from a user device electronically over a communication network, the credit application for applying for two or more credit cards, the credit application being an electronic application form as a single digital file, the electronic application containing user input information received via an interface displayed by the user device;
processing, by the financial institution computing system, the credit application for the two or more credit cards, processing the credit application comprising determining a shared credit line from which the two or more credit cards draw based on information in the credit application, wherein determining the shared credit line comprises approving the shared credit line utilizing a first approval process for a first credit card of the two or more credit cards and a second approval process for a second credit card of the two or more credit cards, each approval process associated with a different card network; and
issuing, by the financial institution computing system, the two or more credit cards to a same user, the two or more credit cards being separate credit cards issued by a same issuer associated with the financial institution computing system, the two or more credit cards being usable by only the same user, the two or more credit cards drawing from the shared credit line, each of the two or more credit cards being associated with the different card network, wherein issuing further comprises generating a mobile wallet account for the same user of the two or more credit cards based on the information in the credit application, and wherein the mobile wallet account is stored on the user device and enables a payment by the two or more credit cards utilizing the shared credit line via a mobile wallet client application of the user device.

2. The method of claim 1, wherein:
the first credit card of the two or more credit cards issued is associated with a first card network; and
the second credit card of the two or more credit cards issued is associated with a second card network.

3. The method of claim 2, wherein the first card network and the second card network are different card networks.

4.-6. (canceled)

7. The method of claim 1, further comprising processing the credit application and issuing a third credit card of the two or more credit cards issued based on the credit application.

8. The method of claim 7, wherein:
the first credit card of the two or more credit cards issued is associated with a first card network;
the second credit card of the two or more credit cards issued is associated with a second card network;
the third credit card of the two or more credit cards issued is associated with a third card network; and
the first card network, the second card network, and third card network are different card networks.

9. (canceled)

10. The method of claim 1, wherein the processing of the credit application for the two or more credit cards comprises:
determining whether to approve the first credit card of the two or more credit cards; and
determining whether to approve the second credit card of the two or more credit cards.

11. The method of claim 1, wherein e issuing of the two or more credit cards comprises:
automatically causing a printer to print the first credit card of the two or more credit cards in response to processing the credit application and determining to approve the first credit card; and
automatically causing the printer to print the second credit card of the two or more credit cards in response to processing the credit application and determining to approve the second credit card.

12. The method of claim 1, wherein the issuing of the two or more credit cards comprises at least one of:
issuing a first payment token to an account of the user associated with the first credit card issued in response to processing the credit application and determining to approve the first credit card; and
issuing a second payment token the account of the user associated with the second credit card issued in response to processing the credit application and determining to approve the second credit card.

13. A financial institution computing system associated with a financial institution; the system comprising:
a network interface structured to facilitate data communication via a network;
a memory; and
a processing circuit comprising a processor, the processing circuit configured to:
receive, from a user device electronically over a communication network, a credit application for applying for two or more credit cards, the credit application being an electronic application form as a single digital file, the electronic application containing user input information received via an interface displayed by the user device;
process, by the financial institution computing system, the two or more credit cards based on the credit application, processing the credit application comprising determining a shared credit line from which the two or more credit cards draw based on information in the credit application, wherein determining the shared credit line comprises approving the shared credit line utilizing a first approval process for a first credit card of the two or more credit cards and a second approval process for a second card of the two or more credit cards, each approval process associated with a different card network; and
issue the two or more credit cards to a same user, the two or more credit cards being separate credit cards issued by a same issuer associated with the financial institution computing system, the two or more credit cards being usable by only the same user, the two or more credit cards drawing from the shared credit line, each of the two or more credit cards being associated with the different card network, wherein issuing further comprises generating a mobile wallet account for the same user of the two or more credit cards based on the information in the credit application, and wherein the mobile wallet account is stored on the user device and enables a payment by the two or more credit cards utilizing the shared credit line via a mobile wallet client application of the user device.

14. The financial institution computing system of claim 13, wherein:
the first credit card of the two or more credit cards issued is associated with a first card network; and
the second credit card of the two or more credit cards issued is associated with a second card network.

15. The financial institution computing system of claim 14, wherein the first card network and the second card network are different card networks.

16.-18. (canceled)

19. The financial institution computing system of claim 13, further comprising processing the credit application and issuing a third credit card of the two or more credit issued.

20. The financial institution computing system of claim 19, wherein:
the first credit card of the two or more credit cards issued is associated with a first card network;
the second credit card of the two or more credit cards issued is associated with a second card network;
the third credit card of the two or more credit cards issued is associated with a third card network; and
the first card network, the second card network, and third card network are different card networks.

21. (canceled)

22. The financial institution computing system of claim 13, wherein the processing of the credit application for the two or more credit cards comprises:
determining whether to approve the first credit card of the two or more credit cards; and
determining whether to approve the second credit card of the two or more credit cards.

23. The financial institution computing system of claim 13, wherein the issuing of the two or more credit cards comprises:
automatically causing a printer to print the first credit card of the two or more credit cards in response to processing the credit application and determining to approve the first credit card; and
automatically causing the printer to print the second credit card of the two or more credit cards in response to processing the credit application and determining to approve the second credit card.

24. The financial institution computing system of claim 13, wherein the issuing of the two or more credit cards comprises:
issuing a first payment token to an account of the user associated with the first credit card issued in response to processing the credit application and determining to approve the first credit card; and
issuing a second payment token the account of the user associated with the second credit card issued in response to processing the credit application and determining to approve the second credit card.
